(19) United States
(12) Patent Application Publication
(10) Pub. No.: US 2024/0426153 A1
(43) Pub. Date: Dec. 26, 2024

(54) Hinge for embedded home appliances and refrigerator

(71) Applicant: HEFEI SNOWKY ELECTRIC CO., LTD, HEFEI (CN)

(72) Inventors: WEI LI, HEFEI (CN); SHISHENG WANG, HEFEI (CN); WEI GU, HEFEI (CN)

(21) Appl. No.: 18/686,246

(22) PCT Filed: Oct. 12, 2023
(86) PCT No.: PCT/CN2023/124276

§ 371 Date: Feb. 23, 2024

(30) Foreign Application Priority Data
Sep. 5, 2022 (CN) 2022110792139

(51) Int. Cl. E05D 7/081; F25D 23/02

(52) U.S. Cl. CPC E05D 7/081; F25D 23/028; E05Y 2900/31; F25D 2323/024

(57) ABSTRACT

A hinge for embedded home appliances, installed in between a door of a home appliance and a casing of the home appliance, includes a hinge body, an end of the hinge body is fixed on the casing of the home appliance; a cam disc is provided on another end of the hinge body, a track frame in a shape of a regular triangle is provided in the door of the home appliance, during revolution of the door of the house appliance against the casing of the home appliance, an inner surface of the track frame moves against an outer surface of the cam disc, and during moving, three points of the outer surface of the cam disc contact the inner surface of the track frame; a household appliance using the hinge for embedded home appliances.

### TECHNICAL FIELD

The present invention relates to the technical field of refrigerators, and specially an embedded home appliances and refrigerator.

### BACKGROUND TECHNOLOGY

Embedded home appliances are domestic appliances that are installed in deep and narrow spaces, for example, decorative cabinets and cupboards. Commonly seen embedded home appliances comprise embedded refrigerators, dishwashers, washing machines, drying machines, microwave ovens and baking ovens.

When opening doors of home appliances, conventional doors revolve against axle centers (where the doors are hinged with the cases), corners of the doors will go beyond the cases, in the embedding space, sufficient gaps have to be reserved for allowing the doors to revolve, which is actually a waste of space, and the big gap is not pleasant in appearance and dust may accumulate there.

A Chinese utility model no. CN216197343U entitled a hinge for embedded doors, realized reduction and track alternation of installation panels of the doors by coordinated rotation and limitation of Reuleaux triangles and track frames, although the amount that the door extends out when being opened is reduced, the amount that has been reduced is small, and does not have significant usage value, and it is still possible to improve the hinge to place the house appliances in deep and narrow spaces more tightly.

### SUMMARY OF THE INVENTION

The present invention aims to overcome the deficiency of the prior art, and provide a hinge for embedded home appliances that makes it possible to place the embedded home appliances in deep and narrow spaces compactly while opening of doors of the home appliances will not be obstructed.

The present invention further provides a home appliance using the foregoing hinge for embedded home appliances.

A first aspect of the present invention provides a hinge for embedded home appliances, installed in between a door of a home appliance and a casing of the home appliance, wherein the hinge comprises a hinge body, an end of the hinge body is fixed on the casing of the home appliance; a cam disc is provided on another end of the hinge body, a track frame in a shape of a regular triangle is provided in the door of the home appliance, the cam disc comprises two short outer circular edges in mirror symmetry and two long outer circular edges in mirror symmetry, the long outer circular edges contact in the two short outer circular edges and are located in between the two short outer circular edges, during revolution of the door of the house appliance against the casing of the home appliance, an inner surface of the track frame moves against an outer surface of the cam disc, and during moving, three points of the outer surface of the cam disc contact the inner surface of the track frame.

A second aspect of the present invention provides a household appliance using the hinge for embedded home appliances, wherein the household appliance comprises the casing of the home appliance and the door of the home appliance provided with the hinge for embedded home appliances set forth in the foregoing paragraph.

The present invention has a simple structure, is easy to manufacture, and can have the door of the home appliance to reduce inwardly during opening, and can avoid effectively obstruction of the door of the home appliance with the deep and narrow space or other articles in the deep and narrow space.

Other features and advantages of the present invention will be set forth in details in the following embodiments.

### BRIEF DESCRIPTION OF DRAWINGS

FIGS. 1 and 2 are installation structural diagrams showing a hinge of embedded home appliances in embodiment 1;

FIG. 3 is a structural diagram showing a hinge body in embodiment 1;

FIG. 4 is a structural diagram (in part) showing a door body of a refrigerator in embodiment 1;

FIG. 5 is a structural diagram showing installation of the door body of the refrigerator and the hinge body in embodiment 1;

FIG. 6 is a structural diagram showing a cam disc in embodiment 1;

FIGS. 7-12 are diagrams showing movement tracks of the cam disc and the track frame in embodiment 2;

FIG. 13 is a diagram showing the door body of the refrigerator when being opened in embodiment 2.

### EMBODIMENTS

In the present description, an embedded refrigerator is used as an example, door bodies of other embedded home appliances can be similar to the door body of the refrigerator, and the casing of the other embedded home appliances can be similar to the casing of the refrigerator, it is only required for the door body to be able to revolve against the casing (for example, embedded dishwashers, washing machines, drying machines, microwave ovens and baking ovens).

### Embodiment 1

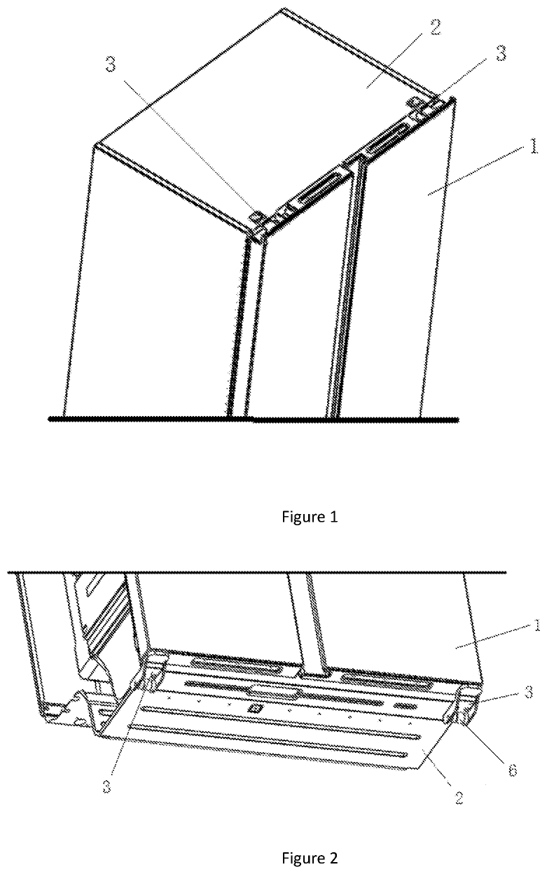

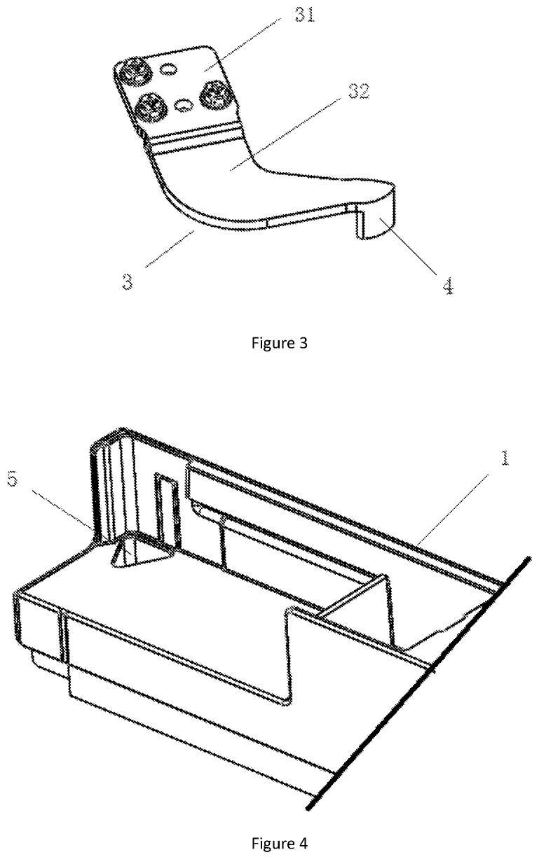

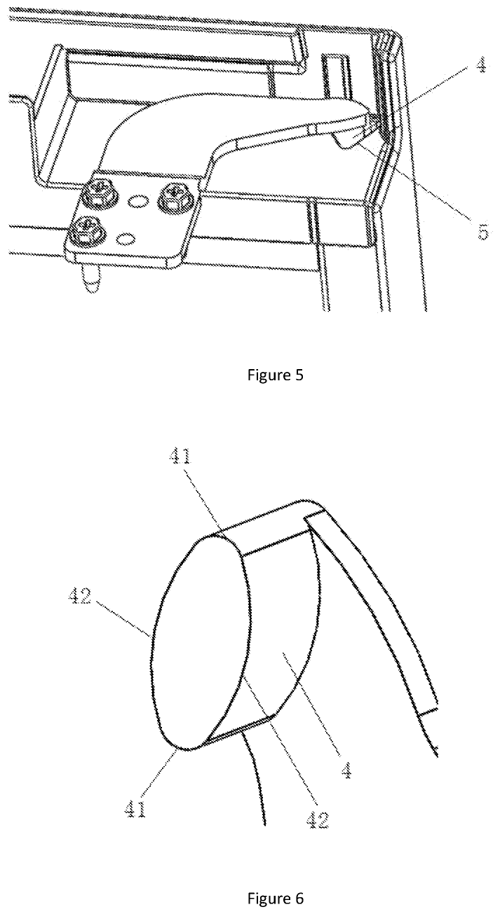

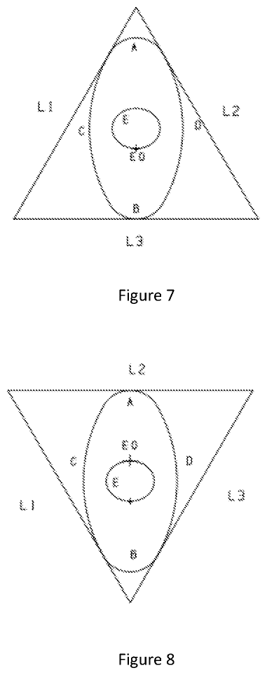

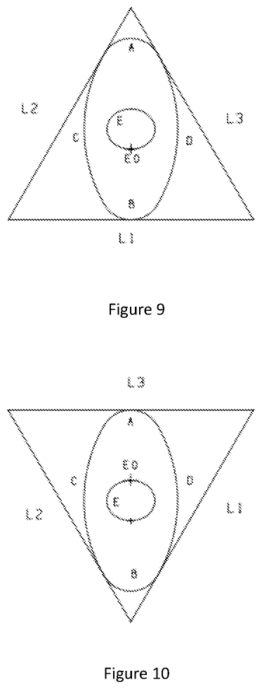

With reference to FIGS. 1 and 2, the present embodiment provides a hinge for embedded home appliances, installed in between a door body 1 of a refrigerator and a casing 2 of the refrigerator, wherein the hinge comprises a hinge body 3, an end of the hinge body 3 is fixed on the casing 2 of the refrigerator (in FIGS. 1 and 2, a side-by-side refrigerator is shown, the hinge body 3 in FIG. 1 is an upper hinge, the hinge body 3 in FIG. 2 is a lower hinge, they are symmetrically provided, apparently, differences in types of refrigerators and positions of the hinges do not affect realization of functions of the hinges, and the hinge works for all of single-door refrigerators, four-door refrigerators and French-door refrigerators), in conjunction with FIGS. 3-5, a cam disc 4 is provided at another end of the hinge body 3, a track frame 5 in a shape of a right triangle is provided in the door body 1 of the refrigerator, in conjunction with FIG. 6, the cam disc 4 comprises two short outer circular edges 41 in mirror symmetry and two long outer circular edges 42 in mirror symmetry, the long outer circular edges 42 contact the two short outer circular edges 41 and reside in between them, during rotation of the door body 1 relative to the casing of the refrigerator 2, an inner surface of the track frame 5 moves along an outer surface of the cam disc 4, and during movement, at any time three points on the outer surface of the cam disc 4 contact the inner surface of the track frame 5. The principle is that, when opening the door body 1 relative to the casing of the refrigerator 2, the inner surface of the track frame 5 moves along the outer surface of the cam disc 4, the door body 1 of the refrigerator with the track frame 5 will retract inwards, and will not protrude for a large distance outwards, so the door of the refrigerator is not liable to hit an inner surface of the deep and narrow surface where the refrigerator is placed or other articles that the refrigerator is adjacent to.

### Embodiment 2

The present embodiment is an explanation on the principle of the embodiment 1:

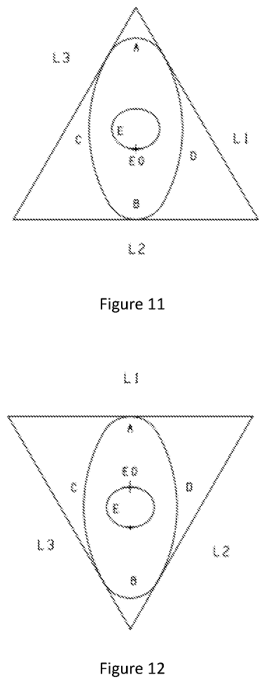

With reference to FIG. 7, three edges of the track frame 5 are respectively L1, L2 and L3;

Two short outer circular edges 41 in the cam disc 4 are respectively A and B;

Two long outer circular edges 42 in the cam disc 4 are respectively C (on the left side in between A and B) and D (on the right side in between A and B);

A central point of the track frame 5 is E₀, and a trajectory of E₀ is E;

Taken as an example counterclockwise rotation of the track frame 5 around the cam disc 4, the trajectory changes in the following way:
1. With reference to FIG. 7, when a line AB is perpendicular to L3, A is located at a sharp corner at a top portion of the track frame 5, and both ends contact respectively L1 and L2; B is located at a center of a bottom edge of the track frame 5, and contacts L3; top ends of C and D have the same contact points as both ends of A, bottom ends of C and D have the same contact point as the contact point of B, therefore, the cam disc 4 has three contact points with L1, L2 and L3;
2. With reference to FIG. 8, when the track frame 5 rotates counterclockwise, when the line AB is perpendicular to L2, B is located at a sharp corner in a bottom portion of the track frame 5, both ends of B contact respectively L1 and L3; A is located at a center of a line at the top portion of the track frame 5, and contacts L2; bottom ends of C and D have the same contact points with the track frame as both ends of B; top ends of C and D have the same contact point as both ends of A, therefore, the cam disc 4 has three contact points with L1, L2 and L3;
3. With reference to FIG. 9, when the track frame 5 rotates counterclockwise and the line AB is perpendicular to L1, A is located at the sharp corner in the top portion of the track frame 5 and both ends of A contact respectively L2 and L3; B is located at a center of the line at the bottom portion of the track frame 5, and contacts L1; top ends of C and D have the same contact points with both ends of A, bottom ends of C and D have the same contact point as B, therefore, the cam disc 4 has three contact points with L1, L2 and L3;
4. With reference to FIG. 10, the track frame 5 rotates counterclockwise, when the line AB is perpendicular to L3, B is located at a sharp corner at a bottom portion of the track frame 5, both ends of B contact respectively L2 and L1; A is located at a center of the top portion of the track frame 5, and contacts L3; bottom ends of C and D have the same contact points as both ends of B, top ends of C and D have same contact points as A, therefore the cam disc 4 has three contact point with L1, L2 and L3;
5. With reference to FIG. 11, the track frame 5 rotates counterclockwise, when the line AB is perpendicular to L2, A is located at the sharp corner at the top portion of the track frame 5, both ends of A contact respectively L3 and L1; B is located at a center of the line at the bottom portion of the track frame 5, and contacts L2; top ends of C and D have the same contact points as both ends of A, bottom ends of C and D have the same contact point as A, therefore, the cam disc 4 has three contact points with L1, L2 and L3;
6. With reference to FIG. 12, the track frame 5 rotates counterclockwise, when the line AB is perpendicular to L1, B is located at the sharp corner at the bottom portion of the track frame 5, both ends of A contact respectively L3 and L2; A is located at the center of the line at the top portion of the track frame 5, and contacts L1; both ends of C and D have the same contact points as both ends of B, top ends of C and D have the same contact point as A, therefore, the cam disc 4 has totally 3 contact points with L1, L2 and L3;
7. Return to step 1, periodically.

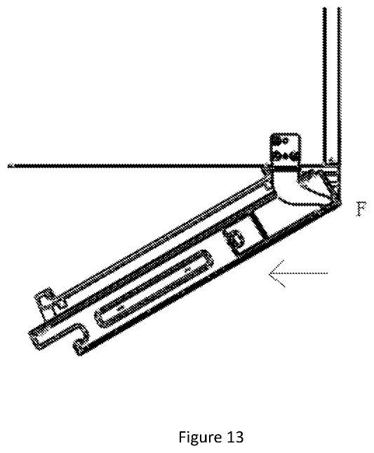

From the foregoing rotation movement tracks, it can be known that, when the track frame 5 moves around the cam disc 4, there are always three contact pints with the cam disc 4, therefore, when the door body 1 rotates relative to the casing 2 of the refrigerator, the track frame 5 will rotate against the cam disc 4 (the hinge body 3 is fixed on the casing 2 of the refrigerator so that during rotation the cam disc 4 is always fixed), during rotation of the track frame 5 against the cam disc 4, as shown in FIG. 13, the door body 1 of the refrigerator will retract inwards, so that a point F which is liable to hit into others successfully avoids any possible obstruction.

Compared with a common hinge that rotates against an axle center, each point in the hinge disclosed in the present invention is changing along with the rotation. Compared with the coordinated rotation and limitation technical solution using at least one Reuleaux triangle block and a track frame, as the Reuleaux triangle block has four contact points with the track frame, the track changes slightly, therefore, the magnitude that the door body retracts inwards is obviously lower than that in the present invention, therefore, with the technical solution in the present invention, the possibility of compact arrangement of the refrigerator in a deep and narrow space and/or other articles in the deep and narrow space is realized, in this way, the refrigerator occupies a smaller space, the gap is smaller and beautiful, no dust will accumulate therein, and viewing from manufacturing, the refrigerator can be of simple structure and involves a low cost.

Furthermore, if radiuses of A and B are configured to be r, radiuses of C and D are configured to be R, it can be inferred that, the a ratio of r/R becomes bigger, the trace change of the door body 1 of the refrigerator will increase, and the magnitude of the door body 1 to retract inwards will correspondingly increase; otherwise, when the ratio of r/R becomes smaller, the trace change of the door body 1 of the refrigerator will reduce, and the magnitude of the door body 1 to retract inwards will reduce correspondingly. And adaptive adjustments can be done as per dimensions of the refrigerator and the space that the refrigerators are to be installed in.

### Embodiment 3

On the basis of embodiment 1, in the present embodiment, three corners of the track frame 5 are rounded. By configuring the corners to be rounded, there are the following benefits: (1) for manufacturing, it is not possible to make an absolute corner, there is a certain degree of roundness at the corners; (2) in this way, the track frame 5 and the cam disc 4 can go closer to a front side and a side of the door body of the refrigerator (where the door body is hinged to the casing), and the extent to which the door body will extend outwards is further reduced and the advantage of the product is further improved.

### Embodiment 4

On the basis of the embodiment 1, with reference to FIG. 3, the hinge body 3 appears to be bended, and comprises an installation portion 31 for connecting with the casing 2 of the refrigerator and a connection panel 32 extending to the door body 1 of the refrigerator, the cam disc 4 is fixed at an end portion of the connection panel 32, with reference to FIG. 3, the track frame 5 is embedded in the door body 1 of the refrigerator. With this design, the refrigerator and the hinge can be easy to manufacture and install, have simple structures and good appearances.

When the hinge body 3 is located at a top portion between the door body 1 and the casing 2 of the refrigerator, a space for housing the connection panel 32 is provided at a top portion of the door body 1 of the refrigerator. The purpose is to facilitate installation of the hinge body 3, and when the door body 1 of the refrigerator is closed, the hinge body 3 can be hidden, when the door body 1 of the refrigerator is opened, the space that the connection panel is shown in is small, so that the refrigerator is pleasant in appearance.

It can be foreseen that, the technical effects in the present invention can be achieved by having the outer surface of the cam disc 4 to move along the inner surface of the track frame 5 and having three contact points between them, and by changing positions of the track frame 5 and the cam disc 4, providing additional connection panels or providing the track frame 5 in the connection panel can also work for this purpose.

### Embodiment 5

On the basis of embodiment 1, with reference to FIG. 2, at least one roller 6 are installed on a bottom surface of the hinge body 3 at a bottom portion in between the door body 1 and the casing 2 of the refrigerator. The at least one roller 6 is installed at the bottom surface of the hinge body, which makes the hinge to have good appearance and be easy to fabricate, and make it convenient to push the refrigerator into the deep and narrow space.

### Embodiment 6

The present embodiment further provides a refrigerator using the foregoing hinge for embedded home appliances, wherein the refrigerator comprises a casing 2 and a door body 1 installed with the foregoing hinge for embedded home appliances. The foregoing are only some preferred embodiments of the present invention, the protection scope of the present invention is not limited to the foregoing embodiment, and all technical solutions within the idea of the present invention are covered in the protection scope of the present invention. It shall be pointed out that for those of ordinary skill in the art, any modifications and improvements to the present invention without departing from the principle of the present invention shall fall into the protection scope of the present invention.

1. A hinge for embedded home appliances, installed in between a door of a home appliance and a casing of the home appliance, comprising a hinge body, an end of the hinge body is fixed on the casing of the home appliance; a cam disc is provided on another end of the hinge body, a track frame in a shape of a regular triangle is provided in the door of the home appliance, the cam disc comprises two short outer circular edges in mirror symmetry and two long outer circular edges in mirror symmetry, the long outer circular edges contact in the two short outer circular edges and are located in between the two short outer circular edges, during revolution of the door of the house appliance against the casing of the home appliance, an inner surface of the track frame moves against an outer surface of the cam disc, and during moving, three points of the outer surface of the cam disc contact the inner surface of the track frame.

2. The hinge for embedded home appliances according to claim 1, wherein, three corners of the track frame are rounded.

3. The hinge for embedded home appliances according to claim 1, wherein, the hinge body is configured to be bended, comprising an installation portion for fixing onto the casing of the home appliance and a connection panel extending to where the hinge is connected with the door of the home appliance, wherein the cam disc is fixed at an end portion of the connection panel and the track frame is embedded in the door of the home appliance.

4. The hinge for embedded home appliances according to claim 3, wherein, when the hinge body is provided at a top portion of the door of the home appliance and the casing of the home appliance, a space for housing the connection panel is provided at the top portion of the door of the home appliance.

5. The hinge for embedded home appliances according to claim 1, wherein, when the hinge body is provided at a bottom portion of the door of the home appliance and the casing of the home appliance, at least one roller is installed at a bottom portion of the hinge body.

6. A home appliance with the hinge for embedded home appliances according to claim 1, wherein the home appliance is provided with the casing of the home appliance and the door of the home appliance using the hinge for embedded appliances.

7. The home appliance with the hinge for embedded home appliances according to claim 2, wherein the home appliance is provided with the casing of the home appliance and the door of the home appliance using the hinge for embedded appliances.

8. The home appliance with the hinge for embedded home appliances according to claim 3, wherein the home appliance is provided with the casing of the home appliance and the door of the home appliance using the hinge for embedded appliances.

9. The home appliance with the hinge for embedded home appliances according to claim 4, wherein the home appliance is provided with the casing of the home appliance and the door of the home appliance using the hinge for embedded appliances.

10. The home appliance with the hinge for embedded home appliances according to claim 5, wherein the home appliance is provided with the casing of the home appliance and the door of the home appliance using the hinge for embedded appliances.
